(19) United States
(12) Patent Application Publication
(10) Pub. No.: US 2020/0036035 A1
(43) Pub. Date: Jan. 30, 2020

(54) LITHIUM ION BATTERY AND PRODUCING METHOD THEREOF

(71) Applicant: Robert Bosch GmbH, Stuttgart (DE)

(72) Inventors: Xiaogang Hao, Shanghai (CN); Rongrong Jiang, Shanghai (CN); Lei Wang, Shanghai (CN); Yuqian Dou, Shanghai (CN)

(21) Appl. No.: 16/310,526

(22) PCT Filed: Jun. 15, 2016
(86) PCT No.: PCT/CN2016/085855

§ 371 Date: Dec. 17, 2018

(51) Int. Cl. H01M 10/0525; H01M 4/04; H01M 4/38; H01M 4/505; H01M 4/525; H01M 4/587

(52) U.S. Cl. CPC H01M 10/0525; H01M 4/0461; H01M 4/386; H01M 2010/4292; H01M 4/525; H01M 4/587; H01M 4/505

(57) ABSTRACT

A lithium ion battery and a method for producing the lithium ion battery are disclosed.

### TECHNICAL FIELD

The present invention relates to a lithium-ion battery, and a method for producing a lithium-ion battery.

### BACKGROUND ART

There are growing demands for the next-generation lithium ion batteries with a high energy density as well as a long cycle life for largescale applications, such as electric vehicles. The Li-ion batteries with high-energy-density anode materials, such as silicon- or tin-based anode materials, have attracted significant attention. One limitation when using these materials is the high irreversible capacity loss, which results in a low Coulombic efficiency in initial cycles; another challenge for using these materials is the poor cycling performance caused by the volume change during charge/discharge.

In the effort to design a high-power battery, the reduction of active material particle size to nano-scale can help shorten the diffusion length of charge carriers, enhance the Li-ion diffusion coefficient, and therefore achieve faster reaction kinetics. However, nano-sized active materials have a large surface area, which results in a high irreversible capacity loss due to the formation of a solid electrode interface (SEI). For silicon oxide based anode, the irreversible reaction during the first lithiation also leads to a large irreversible capacity loss in initial cycle. This irreversible capacity loss consumes Li in the cathode, which decreases the capacity of the full cell.

Even worse, for Si-based anode, repeated volume change during cycling reveals more and more fresh surface on the anode, which leads to continuous growth of SEI. And the continuous growth of SEI continuously consumes Li in the cathode, which results in capacity decay for the full cell.

In order to provide more lithium ions to compensate for an SEI or other lithium consumption during the formation, additional or supplementary Li may be provided by the prelithiation of the anode. If the prelithiation of the anode is conducted, the irreversible capacity loss could be compensated in advance instead of Li consumption from the cathode. This results in higher efficiency and capacity of the cell.

However, a pre-lithiation degree of exact compensation for the irreversible loss of lithium from the anode doesn't help to solve the problem of Li consumption from the cathode during cycling. Therefore, in this case, the cycling performance will not be improved. To compensate for the loss of lithium from the cathode during cycling, an over-prelithiation is conducted in the present invention.

### SUMMARY OF INVENTION

In general, when the cathode efficiency is higher than the anode efficiency, a prelithiation can effectively increase the cell capacity via increasing the initial Coulombic efficiency. In this case, maximum energy density can be reached. For a cell, in which the loss of lithium during cycling may occur, prelithiation can also improve the cycling performance when an over-prelithiation is applied. The over-prelithiation provides a reservoir of lithium in the whole electrochemical system and the extra lithium in the anode compensates the possible lithium consumption from the cathode during cycling.

In principle, the higher prelithiation degree, the better cycling performance could be achieved. However, a higher prelithiation degree involves a much larger anode. Therefore, the cell energy density will decrease due to the increased weight and volume of the anode. Therefore, the prelithiation degree should be carefully controlled to balance the cycling performance and the energy density.

The present invention, according to one aspect, relates to a lithium-ion battery comprising a cathode, an anode, and an electrolyte, wherein the initial surface capacity a of the cathode and the initial surface capacity b of the anode satisfy the relation formulae

1<(b·(1−ε)/a)≤1.2 (I),

0<ε≤((a·η₁)/0.6−(a−b·(1−η₂)))/b (II),

where
ε is the prelithiation degree of the anode,
η₁ is the initial coulombic efficiency of the cathode, and
η₂ is the initial coulombic efficiency of the anode.

The present invention, according to another aspect, relates to a method for producing a lithium-ion battery comprising a cathode, an anode, and an electrolyte, wherein said method includes the following steps:

1) prelithiating the active material of the anode or the anode to a prelithiation degree ε, and

2) assembling the anode and the cathode to obtain said lithium-ion battery, characterized in that the initial surface capacity a of the cathode, the initial surface capacity b of the anode, and the prelithiation degree ε satisfy the relation formulae

1<(b·(1−ε)/a)≤1.2 (I),

0<ε≤((a·η₁)/0.6−(a−b·(1−η₂)))/b (II),

where

ε is the prelithiation degree of the anode,

η₁ is the initial coulombic efficiency of the cathode, and

η₂ is the initial coulombic efficiency of the anode.

### BRIEF DESCRIPTION OF DRAWINGS

Each aspect of the present invention will be illustrated in more detail in conjunction with the accompanying drawings, wherein:

FIG. 1 shows the cycling performances of the full cells of Example P1-E1;

FIG. 2 shows the normalized energy densities of the full cells of Example P1-E1;

FIG. 3 shows the cycling performances of the full cells of Example P1-E2;

FIG. 4 shows the normalized energy densities of the full cells of Example P1-E2;

FIG. 5 shows the cycling performances of the full cells of Example P1-E3 with the prelithiation degrees ε of a) 0 and b) 22%.

### DETAILED DESCRIPTION OF PREFERRED EMBODIMENTS

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

The present invention, according to one aspect, relates to a lithium-ion battery comprising a cathode, an anode, and an electrolyte, wherein the initial surface capacity a of the cathode and the initial surface capacity b of the anode satisfy the relation formulae

1<(b·(1−ε)/a)≤1.2 (I),

0<ε≤((a·η₁)/0.6−(a−b·(1−η₂)))/b (II),

where

ε is the prelithiation degree of the anode,

η₁ is the initial coulombic efficiency of the cathode, and

η₂ is the initial coulombic efficiency of the anode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

According to the present invention, the term “prelithiation degree” ε of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

In accordance with an embodiment of the lithium-ion battery according to the present invention, the initial surface capacity a of the cathode and the initial surface capacity b of the anode satisfy the relation formulae

1.05≤(b·(1−ε)/a)≤1.15 (Ia),

preferably 1.08≤(b·(1−ε)/a)≤1.12 (Ib).

In accordance with another embodiment of the lithium-ion battery according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where

c is the depth of discharge (DoD) of the anode.

In particular, ε=(b·(1−η₂)−a·(1−η₁))/b, when c=1.

In accordance with another embodiment of the lithium-ion battery according to the present invention, the active material of the anode can be selected from the group consisting of carbon, silicon, silicon intermetallic compound, silicon oxide, silicon alloy and mixtures thereof.

In accordance with another embodiment of the lithium-ion battery according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

The present invention, according to another aspect, relates to a method for producing a lithium-ion battery comprising a cathode, an anode, and an electrolyte, wherein said method includes the following steps:

1) prelithiating the active material of the anode or the anode to a prelithiation degree ε, and

2) assembling the anode and the cathode to obtain said lithium-ion battery, characterized in that the initial surface capacity a of the cathode, the initial surface capacity b of the anode, and the prelithiation degree a satisfy the relation formulae

1<(b·(1−ε)/a)≤1.2 (I),

0<ε≤((a·η₁)/0.6−(a−b·(1−η₂)))/b (II),

where

ε is the prelithiation degree of the anode,

η₁ is the initial coulombic efficiency of the cathode, and

η₂ is the initial coulombic efficiency of the anode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

According to the present invention, the term “prelithiation degree” ε of the anode can be calculated by (b−a*x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

The prelithiation process is not particularly limited. The lithiation of the anode active material substrate can be carried out for example in several different ways. A physical process includes deposition of a lithium coating layer on the surface of the anode active material substrate such as silicon particles, thermally induced diffusion of lithium into the substrate such as silicon particles, or spray of stabilized Li powder onto the anode tape. An electrochemical process includes using silicon particles and a lithium metal plate as the electrodes, and applying an electrochemical potential so as to intercalate Li⁺ ions into the bulk of the silicon particles. An alternative electrochemical process includes assembling a half cell with silicon particles and Li metal foil electrodes, charging the half cell, and disassembling the half cell to obtain lithiated silicon particles.

In accordance with an embodiment of the method according to the present invention, the initial surface capacity a of the cathode and the initial surface capacity b of the anode satisfy the relation formulae

1.05≤(b·(1−ε)/a)≤1.15 (Ia),

preferably 1.08≤(b·(1−ε)/a)≤1.12 (Ib).

In accordance with another embodiment of the method according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where

c is the depth of discharge (DoD) of the anode.

In particular, ε=(b·(1−η₂)−a·(1−η₁))/b, when c=1.

In accordance with another embodiment of the method according to the present invention, the active material of the anode can be selected from the group consisting of carbon, silicon, silicon intermetallic compound, silicon oxide, silicon alloy and mixtures thereof.

In accordance with another embodiment of the method according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

### Examples P1 for Prelithiation

Active material of the cathode: NCM-111 from BASF, and HE-NCM prepared according to the method as described in WO 2013/097186 A1;
Active material of the anode: a mixture (1:1 by weight) of silicon nanoparticle with a diameter of 50 nm from Alfa Aesar and graphite from Shenzhen Kejingstar Technology Ltd.;
Carbon additives: flake graphite KS6L and Super P Carbon Black C65 from Timcal; Binder: PAA, Mv=450,000, from Sigma Aldrich;
Electrolyte: 1M LiPF₆/EC(ethylene carbonate)+DMC(dimethyl carbonate) (1:1 by volume);
Separator: PP/PE/PP membrane Celgard 2325.

### Example P1-E1

At first anode/Li half cells were assembled in form of 2016 coin cell in an Argon-filled glove box (MB-10 compact, MBraun), wherein lithium metal was used as the counter electrode. The assembled anode/Li half cells were discharged to the designed prelithiation degree ε as given in Table P1-E1, so as to put a certain amount of Li⁺ ions in the anode, i.e., the prelithiation of the anode. Then the half cells were disassembled. The prelithiated anode and NCM-111 cathode were assembled to obtain 2032 coin full cells. The cycling performances of the full cells were evaluated at 25° C. on an Arbin battery test system at 0.1 C for formation and at 1 C for cycling.

TABLE P1-E1

| Group | a | η₁ | b | η₂ | ε | c | x | η_{F} | Life |
|---|---|---|---|---|---|---|---|---|---|
| G0 | 2.30 | 90% | 2.49 | 87% | 0 | 1.00 | 1.08 | 83% | 339 |
| G1 | 2.30 | 90% | 2.68 | 87% | 5.6% | 0.99 | 1.10 | 86% | 353 |
| G2 | 2.30 | 90% | 3.14 | 87% | 19.5% | 0.83 | 1.10 | 89% | 616 |
| G3 | 2.30 | 90% | 3.34 | 87% | 24.3% | 0.77 | 1.10 | 88% | 904 |
| G4 | 2.30 | 90% | 3.86 | 87% | 34.6% | 0.66 | 1.10 | 89% | 1500 |

a initial delithiation capacity of the cathode [mAh/cm²];
η₁ initial Coulombic efficency of the cathode;
b initial lithiation capacity of the anode [mAh/cm²];
η₂ initial Coulombic efficency of the anode;
ε prelithiation degree of the anode;
c depth of discharge of the anode;
x = b · (1 − ε)/a, balance of the anode and cathode capacities after prelithiation;
η_{F} initial Coulombic efficiency of the full cell;
Life cycle life of the full cell (80% capacity retention).

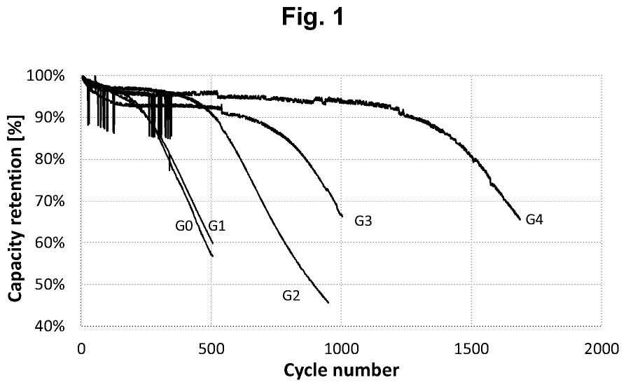

FIG. 1 shows the cycling performances of the full cells of Groups G0, G1, G2, G3, and G4 of Example P1-E1.

In case of Group G0 with a prelithiation degree ε=0, the capacity of the full cell was decreased to 80% after 339 cycles.

In case of Group G1 with a prelithiation degree of 5.6%, the prelithiation amount was only enough to compensate the irreversible Li loss difference between the cathode and the anode. Therefore, the initial Coulombic efficiency was increased from 83% to 86%, while no obvious improvement in cycling performance was observed.

In case of Group G2 with a prelithiation degree increased to 19.5%, the prelithiation amount was not only enough to compensate the irreversible Li loss difference between the cathode and the anode, but also extra amount of Li was reserved in the anode to compensate the Li loss during cycling. Hence, the cycle life was greatly improved to 616 cycles.

In case of Groups G3 and G4 with further increased prelithiation degrees, more and more Li was reserved in the anode, so better and better cycling performances were obtained.

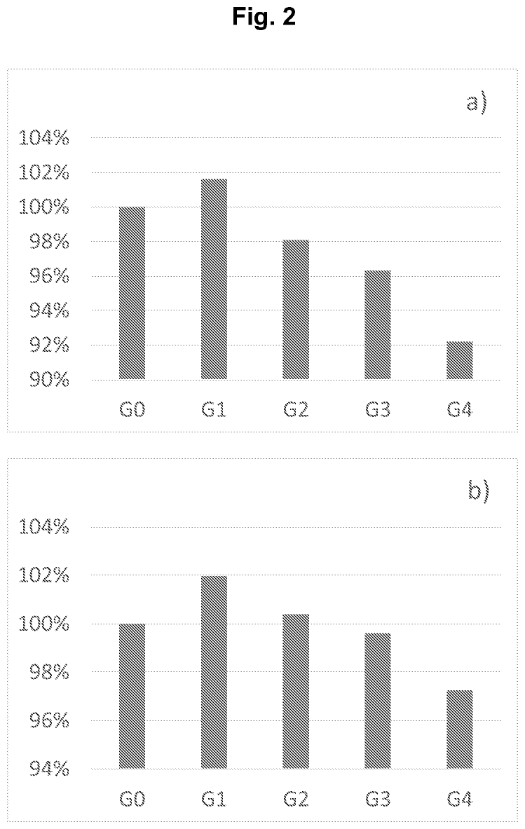

FIG. 2 shows a) the volumetric energy densities and b) the gravimetric energy densities of the full cells of Groups G0, G1, G2, G3, and G4 in Example P1-E1. Compared with non-prelithiation (G0), Group G1 with 5.6% prelithiation degree shows a higher energy density due to the higher capacity. In case of the further increased prelithiation degree for a better cycling performance, the energy density decreases to some extend but still has more than 90% energy density of G0 when prelithiation degree reaches 34.6% in G4.

### Example P1-E2

Example P1-E2 was carried out similar to Example P1-E1, except that HE-NCM was used as the cathode active material and the corresponding parameters were given in Table P1-E2.

TABLE P1-E2

| Group | a | η₁ | b | η₂ | ε | c | x | η_{F} | Life |
|---|---|---|---|---|---|---|---|---|---|
| G0 | 3.04 | 96% | 3.25 | 87% | 0 | 1.00 | 1.07 | 85% | 136 |
| G1 | 3.04 | 96% | 4.09 | 87% | 18.3% | 0.90 | 1.10 | 94% | 231 |
| G2 | 3.04 | 96% | 4.46 | 87% | 26.3% | 0.80 | 1.08 | 95% | 316 |

a initial delithiation capacity of the cathode [mAh/cm²];
η₁ initial Coulombic efficency of the cathode;
b initial lithiation capacity of the anode [mAh/cm²];
η₂ initial Coulombic efficency of the anode;
ε prelithiation degree of the anode;
c depth of discharge of the anode;
x = b · (1 − ε)/a, balance of the anode and cathode capacities after prelithiation;
η_{F} initial Coulombic efficiency of the full cell;
Life cycle life of the full cell (80% capacity retention).

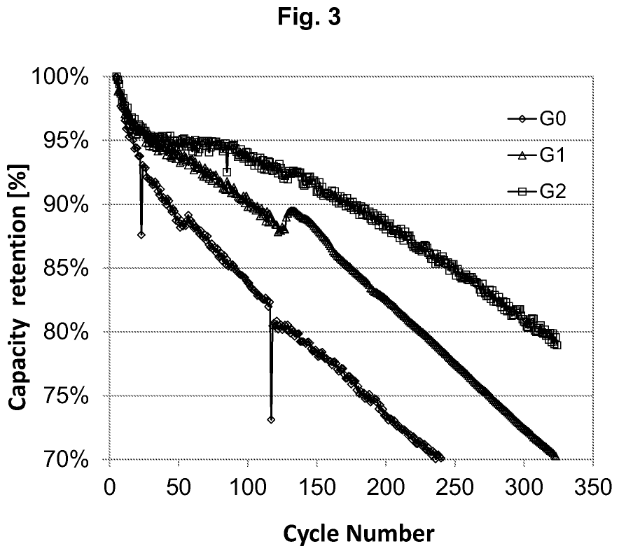

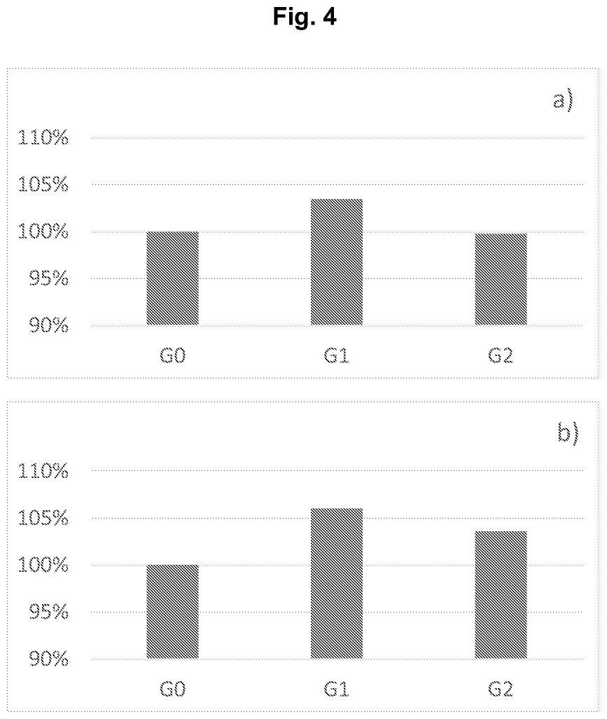

FIG. 3 shows the cycling performances of the full cells of Groups G0, G1, and G2 of Example P1-E2. FIG. 4 shows a) the volumetric energy densities and b) the gravimetric energy densities of the full cells of Groups G0, G1, and G2 of Example P1-E2. It can been seen from Table P1-E2 that the initial Coulombic efficiencies of the full cells were increased from 85% to 95% in case of the prelithiation. Although larger anodes were used for prelithiation, the energy density did not decrease, or even a higher energy density was reached, compared with non-prelithiation in G0. Moreover, the cycling performances were greatly improved, because the Li loss during cycling was compensated by the reserved Li.

### Example P1-E3

Example P1-E3 was carried out similar to Example P1-E1, except that pouch cells were assembled instead of coin cells, and the corresponding prelithiation degrees ε of the anode were a) 0 and b) 22%.

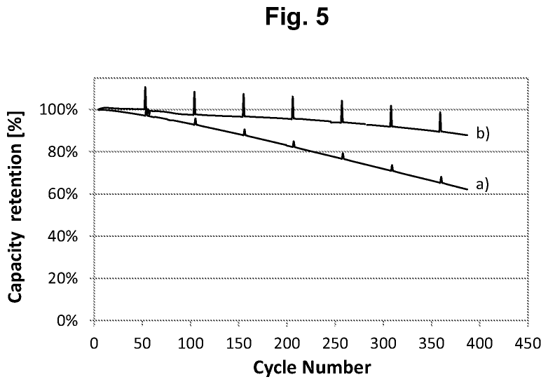

FIG. 5 shows the cycling performances of the full cells of Example P1-E3 with the prelithiation degrees ε of a) 0 and b) 22%. It can been seen that the cycling performance was much improved in case of the prelithiation.

While certain embodiments have been described, these embodiments have been presented by way of example only, and are not intended to limit the scope of the inventions. The attached claims and their equivalents are intended to cover all the modifications, substitutions and changes as would fall within the scope and spirit of the invention.

1. A lithium-ion battery comprising a cathode, an anode, and an electrolyte, wherein the initial surface capacity a of the cathode and the initial surface capacity b of the anode satisfy the relation formulae
1<(b·(1−ε)/a)≤1.2 (I),
0<ε≤((a·η₁)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

2. The lithium-ion battery of claim 1, characterized in that
ε=((a·η₁)/c−(a−b·(1−η₂)))/b (III),
0.6≤c<1 (IV),
where
c is the depth of discharge of the anode.

3. The lithium-ion battery of claim 1, characterized in that the active material of the anode is selected from the group consisting of carbon, silicon, silicon intermetallic compound, silicon oxide, silicon alloy and mixtures thereof.

4. The lithium-ion battery of claim 1, characterized in that the active material of the cathode is selected from the group consisting of lithium nickel oxide, lithium cobalt oxide, lithium manganese oxide, lithium nickel cobalt oxide, lithium nickel cobalt manganese oxide, and mixtures thereof.

5. A method for producing a lithium-ion battery comprising a cathode, an anode, and an electrolyte, wherein said method includes the following steps:
1) prelithiating the active material of the anode or the anode to a prelithiation degree ε, and
2) assembling the anode and the cathode to obtain said lithium-ion battery, characterized in that the initial surface capacity a of the cathode, the initial surface capacity b of the anode, and the prelithiation degree ε satisfy the relation formulae
1<(b·(1−ε)/a)≤1.2 (I),
0<ε≤((a·η₁)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

6. The method of claim 5, characterized in that
ε=((a·η₁)/c−(a−b·(1−η₂)))/b (III),
0.6≤c<1 (IV),
where
c is the depth of discharge of the anode.

7. The method of any one of claim 5, characterized in that the active material of the anode is selected from the group consisting of carbon, silicon, silicon intermetallic compound, silicon oxide, silicon alloy and mixtures thereof.

8. The method of claim 5, characterized in that the active material of the cathode is selected from the group consisting of lithium nickel oxide, lithium cobalt oxide, lithium manganese oxide, lithium nickel cobalt oxide, lithium nickel cobalt manganese oxide, and mixtures thereof.

9. The lithium-ion battery of claim 1, wherein the initial surface capacity a of the cathode and the initial surface capacity b of the anode satisfy the relation formulae
1.05≤(b·(1−ε)/a)<1.15 (Ia),
0<ε≤((a·η₁)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

90. The lithium-ion battery of claim 1, wherein the initial surface capacity a of the cathode and the initial surface capacity b of the anode satisfy the relation formulae
1.08≤(b·(1−ε)/a)≤1.12 (Ib),
0<ε≤((a·η₁)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

11. The lithium-ion battery of claim 1, characterized in that
ε=((a·η₁)/c−(a−b·(1−η₂)))/b (III),
0.7≤c<1 (IVa),
where
c is the depth of discharge of the anode.

110. The lithium-ion battery of claim 1, characterized in that
ε=((a·η₁)/c−(a−b·(1−η₂)))/b (III),
0.7≤c≤0.9 (IVb),
where
c is the depth of discharge of the anode.

13. The lithium-ion battery of claim 1, characterized in that
ε=((a·η₁)/c−(a−b·(1−η₂)))/b (III),
0.75≤c≤0.85 (IVc),
where
c is the depth of discharge of the anode.

14. The method of claim 5, wherein the initial surface capacity a of the cathode, the initial surface capacity b of the anode, and the prelithiation degree ε satisfy the relation formulae
1.05≤(b·(1−ε)/a)≤1.15 (Ia),
0<ε≤((a·η₁)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

111. The method of claim 5, wherein the initial surface capacity a of the cathode, the initial surface capacity b of the anode, and the prelithiation degree ε satisfy the relation formulae
1.08≤(b·(1−ε)/a)≤1.12 (Ib),
0<ε≤((a·η₁)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

112. The method of claim 5, characterized in that
ε=((a·η₁)/c−(a−b·(1−η₂)))/b (III),
0.7≤c<1 (IVa),
where
c is the depth of discharge of the anode.

17. The method of claim 5, characterized in that
ε=((a·η₁)/c−(a−b·(1−η₂)))/b (III),
0.7≤c≤0.9 (IVb),
where
c is the depth of discharge of the anode.

18. The method of claim 5, characterized in that
ε=((a·η₁)/c−(a−b·(1−η₂)))/b (III),
0.75≤c≤0.85 (IVc),
where
c is the depth of discharge of the anode.
